(19) United States
(12) Patent Application Publication
(10) Pub. No.: US 2025/0079863 A1
(43) Pub. Date: Mar. 6, 2025

(54) WIRELESS CHARGING METHOD AND DEVICE

(71) Applicants: INVENTEC (PUDONG) TECHNOLOGY CORPORATION, Shanghai (CN); INVENTEC CORPORATION, Taipei City (TW)

(72) Inventor: Ting Kai CHEN, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/510,076

(22) Filed: Nov. 15, 2023

(30) Foreign Application Priority Data
Aug. 28, 2023 (CN) 202311097482.2

(51) Int. Cl. H02J 7/00; H02J 50/10; H02J 50/80

(52) U.S. Cl. CPC H02J 7/005; H02J 50/10; H02J 50/80

(57) ABSTRACT

A wireless charging method includes: obtaining a battery health level of a target device; determining whether the battery health level is lower than a preset health level; when the battery health level is not lower than the preset health level, charging the target device with first power, and when the battery health level is lower than the preset health level, charging the target device with second power smaller than the first power.

### CROSS-REFERENCE TO RELATED APPLICATIONS

This non-provisional application claims priority under 35 U.S.C. § 119 (a) on Patent Application No(s). 202311097482.2 filed in China on Aug. 28, 2023, the entire contents of which are hereby incorporated by reference.

### BACKGROUND

### 1. Technical Field

This disclosure relates to a wireless charging method and device.

### 2. Related Art

The applications of near-field communication (NFC) in wireless charging mainly include NFC wireless charger position tracking, NFC wireless charger automatic switch, NFC wireless charging multi-purpose function, NFC wireless charger safety control, and NFC wireless charger interactive functions. In near-field communication applications, antennas are usually used as components for transmitting and receiving wireless signals, and the antenna is used to transmit data between the wireless charger and the device to be charged.

However, nowadays, when wireless charging devices charge the device to be charged, a near-field communication antenna is usually directly used to obtain the charging information of the device to be charged, and then charge the device to be charged according to the charging power corresponding to the device charging information. As a result, if the battery health level of the device to be charged is low, charging the device to be charged directly according to the charging information will cause problems such as reduced battery life, battery overheating, battery overcharging, and battery burning.

### SUMMARY

Accordingly, this disclosure provides a wireless charging method and device.

According to one or more embodiment of this disclosure, a wireless charging device includes a charging module, a signal acquisition module and a control module, wherein the control module is connected to the charging module and the signal acquisition module. The wireless charging device is configured to wirelessly charge a target device. The signal acquisition module is configured to obtain a battery health level of the target device. The control module is configured to determine whether the battery health level is lower than a preset health level. When the battery health level is not lower than the preset health level, the control module controls the charging module to charge the target device with first power, and when the battery health level is lower than the preset health level, the control module controls the charging module to charge the target device with second power smaller than the first power.

According to one or more embodiment of this disclosure, a wireless charging method includes: obtaining a battery health level of a target device; determining whether the battery health level is lower than a preset health level; when the battery health level is not lower than the preset health level, charging the target device with first power; and when the battery health level is lower than the preset health level, charging the target device with second power smaller than the first power.

In view of the above description, the wireless charging method and device of the present disclosure may determine whether the battery health level is lower than the preset health level by obtaining the battery health level of the target device. When the battery health level of the target device is lower than the preset health level, the target device is charged with charging power that is lower than another charging power originally applicable to the target device. Thus, compared with wireless charging method and device that do not adjust the charging strategy according to the battery health level of the target device, the wireless charging method and device of the present disclosure may delay battery degradation, thereby increasing battery life, and reduce the possibility of overcharging and overheating.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a wireless charging device according to an embodiment of the present disclosure;

FIG. 2 is a flow chart of a wireless charging method according to an embodiment of the present disclosure; and

FIG. 3 is a flow chart of obtaining system information of a target device of a wireless charging method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

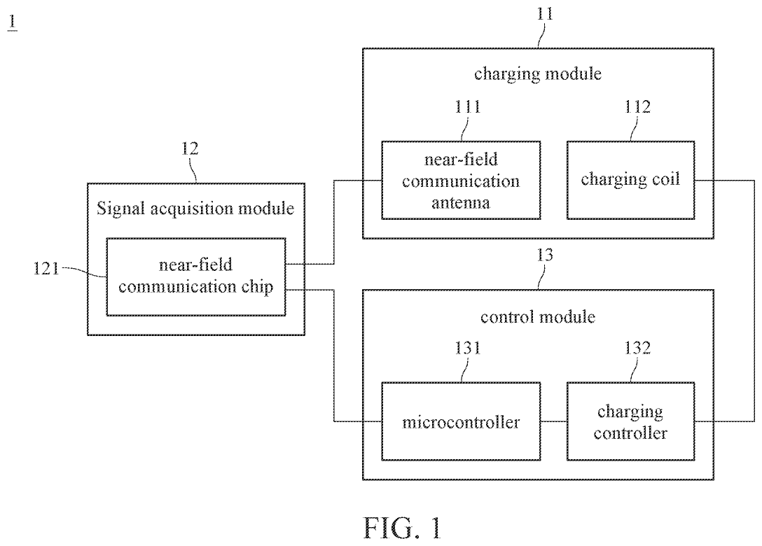

Please refer to FIG. 1 which is a functional block diagram of a wireless charging device according to an embodiment of the present disclosure. As shown in FIG. 1, the wireless charging device 1 includes a charging module 11, a signal acquisition module 12 and a control module 13, wherein the control module 13 is connected to the charging module 11 and the signal acquisition module 12.

The charging module 11 is configured to wirelessly charge a target device, for example, an electronic device with a wireless charging function, such as a mobile phone. The charging module 11 may include a near-field communication antenna 111 and a charging coil 112. Specifically, the charging module 11 may perform wireless communication through the near-field communication antenna 111, and may charge the target device through the charging coil 112.

The signal acquisition module 12 is configured to obtain a battery health level of the target device. Specifically, the signal acquisition module 12 may include a near-field communication chip 121, and is connected to a near-field communication antenna 111 of the charging module 11 and the control module 13. Furthermore, the near-field communication chip 121 may receive a signal including the battery health level of the target device from the target device through the near-field communication antenna 111.

The control module 13 may include a microcontroller 131 and a charging controller 132. The microcontroller 131 is connected to the charging controller 132 and the near-field communication chip 121 of the signal acquisition module 12, and the charging controller 132 is connected to the charging coil 112 of the charging module 11. The microcontroller 131 is configured to determine whether the battery health level is lower than a preset health level. When the battery health level is not lower than the preset health level, the charging controller 132 controls the charging module 11 to charge the target device with first power, and when the battery health is lower than the preset health level, the charging controller 132 controls the charging module to charge the target device with second power lower than the first power. Specifically, the first power may meet the current requirements and specification reported by the target device through the Qi protocol. The specification is, for example, an Extended Power Profile (EPP), and the second power may comply with the Baseline Power Profile (BPP). In other words, when the battery health level of the target device is normal, the control module 13 may control the charging module 12 to charge the target device according to the original specifications of the target device, and when the battery health level of the target device is in a low-standard state, the control module 13 adapts a charging strategy of lower power.

The Qi protocol is a wireless charging standard developed by the Wireless Power Consortium (WPC). Its main purpose is to avoid safety and compatibility issues that may arise in the use of wireless charging products. With the popularity of wireless charging products, the market's requirements for charging efficiency have also greatly increased. Therefore, when drafting the Qi wireless charging standard, WPC defined the baseline power specification and extended power specification according to the output power, that is, the baseline power specification supports power transfer of 5 watts (W), and the extended power specification supports power transfer in the power range greater than 5W and smaller than 30W.

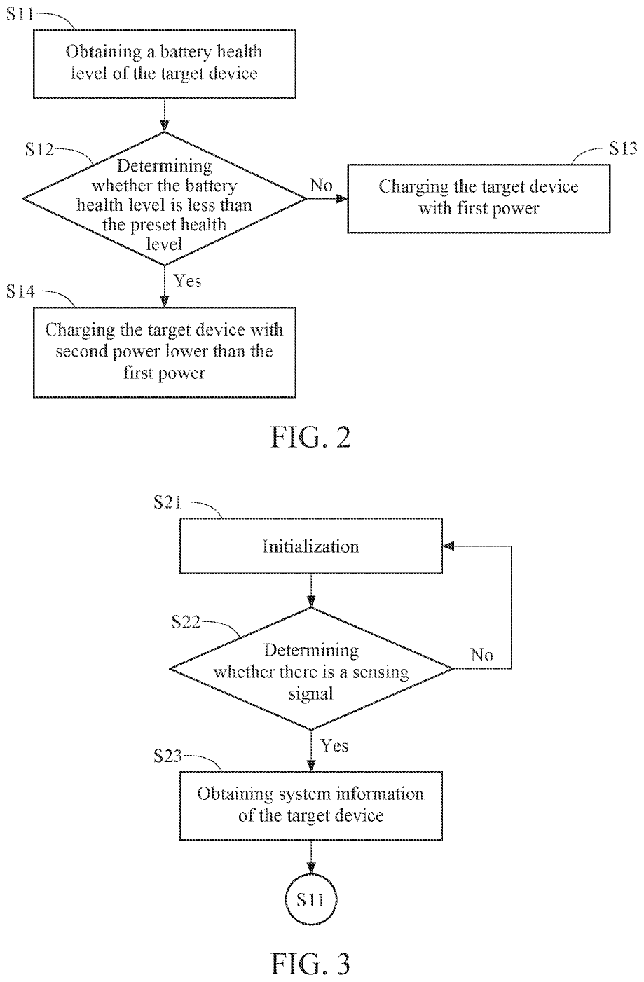

Please refer to FIG. 2 along with FIG. 1, FIG. 2 is a flow chart of a wireless charging method according to an embodiment of the present disclosure. As shown in FIG. 2, the wireless charging method includes step S11: obtaining a battery health level of the target device; step S12: determining whether the battery health level is lower than the preset health level; when the determination result of step S12 is “no”, executing step S13: charging the target device with first power; and when the determination result of step S12 is “yes”, execute step S14: charging the target device with second power lower than the first power. The above-mentioned wireless charging method may be applied to the wireless charging device 1 shown in FIG. 1. The wireless charging method shown in FIG. 2 will be described below by taking the wireless charging device 1 shown in FIG. 1 as an example.

In step S11, the microcontroller 131 obtains the battery health level of the target device. Specifically, the battery health level may be obtained through near-field communication technology. Furthermore, the battery health level of the target device may be obtained by conducting the near-field communication chip 121 and the near-field communication antenna 111 provided in the charging module 11 to obtain the battery health signal transmitted from the target device.

In step S12, the microcontroller 131 determines whether the battery health level is lower than the preset health level. Specifically, when the determination result of step S12 is that the battery health level is not lower than the preset health level, step S13 is executed. When the determination result of step S12 is that the battery health level is lower than the preset health level, step S14 is executed. Furthermore, the preset health level may be 20%.

In step S13, the charging module 11 charges the target device with the first power. Specifically, the microcontroller 131 may control the charging coil 112 provided in the charging module 11 to charge the target device with the first power. Furthermore, the first power may comply with the current required power and specification (such as EPP) reported by the target device through the Qi protocol.

In step S14, the charging module 11 charges the target device with the second power that is lower than the first power. Specifically, the microcontroller 131 may control the charging coil 112 provided in the charging module 11 to charge the target device with the second power that is lower than the first power. Furthermore, the second power may comply with the BPP.

Please refer to FIG. 3 along with FIG. 1, FIG. 3 is a flow chart of obtaining system information of a target device of a wireless charging method according to an embodiment of the present disclosure. As shown in FIG. 3, in addition to steps S11 to S14, the wireless charging method further includes step S21: initialization, which is executed before step S11; step S22: determining whether there is a sensing signal; when the determination result of step S22 is “yes”, executing step S23: obtaining system information of the target device; and when the determination result of step S12 is “no”, executing steps S21 and S22 again.

In steps S21 and S22, the microcontroller 131 is initialized and determines whether there is a sensing signal. Specifically, when the determination result of step S22 is that the near-field communication antenna 111 senses a signal, step S23 is executed. When the determination result of step S22 is that the near-field communication antenna 111 does not sense a signal, step S21 and the following steps are executed again.

In step S23, the microcontroller 131 obtains system information of the target device. Specifically, the system information of the target device may be obtained through the signal acquisition module 12. That is, the system information of the target device may be obtained by conducting the near-field communication chip 121 provided in the signal acquisition module 12 and the near-field communication antenna 111 provided in the charging module 11. Furthermore, after obtaining the system information of the target device, a preset reading process corresponding to the system information may be used to obtain the battery health level of the target device. Furthermore, the system information may indicate the system software type of the target device. Taking a mobile device as an example, the system information may indicate its mobile operating system, such as Android operating system or IOS operating system.

In one or more embodiments of the present disclosure, the wireless charging device of the present disclosure may be applied to vehicle-mounted devices, such as self-driving cars, electric cars, semi-autonomous cars, etc.

In view of the above description, the wireless charging method and device of the present disclosure may determine whether the battery health level is lower than the preset health level by obtaining the battery health level of the target device. When the battery health level of the target device is lower than the preset health level, the target device is charged with charging power that is lower than another charging power originally applicable to the target device. Thus, compared with wireless charging method and device that do not adjust the charging strategy according to the battery health level of the target device, the wireless charging method and device of the present disclosure may delay battery degradation, thereby increasing battery life, and reduce the possibility of overcharging and overheating.

What is claimed is:

1. A wireless charging method, executed by a wireless charging device, comprising:
obtaining a battery health level of a target device;
determining whether the battery health level is lower than a preset health level;
charging the target device with first power when the battery health level is not lower than the preset health level; and
charging the target device with second power smaller than the first power when the battery health level is lower than the preset health level.

2. The wireless charging method of claim 1, further comprising:
obtaining system information of the target device before obtaining the battery health level of the target device;
wherein the battery health level of the target device is obtained through a preset reading process corresponding to the system information.

3. The wireless charging method of claim 1, wherein the battery health level is obtained through a near-field communication technology.

4. The wireless charging method of claim 1, wherein the second power complies with a baseline power profile.

5. The wireless charging method of claim 1, wherein the preset health level is 20%.

6. A wireless charging device, configured to wirelessly charge a target device, comprising:
a charging module;
a signal acquisition module configured to obtain a battery health level of the target device; and
a control module connected to the charging module and the signal acquisition module, and configured to determine whether the battery health level is lower than a preset health level, charge the target device with first power when the battery health level is not lower than the preset health level, and charge the target device with second power smaller than the first power when the battery health level is lower than the preset health level.

7. The wireless charging device of claim 6, wherein the control module is further configured to obtain system information of the target device before obtaining the battery health level of the target device, wherein the signal acquisition module obtains the battery health level of the target device through a preset reading process corresponding to the system information.

8. The wireless charging device of claim 6, wherein the charging module comprises a near-field communication antenna, and the signal acquisition module comprises:
a near-field communication chip connected to the near-field communication antenna and the control module, and configured to receive a signal including the battery health level from the target device through the near-field communication antenna.

9. The wireless charging device of claim 6, wherein the second power complies with a baseline power profile.

10. The wireless charging device of claim 6, wherein the preset health level is 20%.
